(19) United States
(12) Patent Application Publication
(10) Pub. No.: US 2026/0159677 A1
(43) Pub. Date: Jun. 11, 2026

(54) PROPYLENE-BASED COPOLYMER COMPOSITION FOR PIPES

(71) Applicant: Basell Poliolefine Italia S.r.l., Milano (IT)

(72) Inventors: Marco Bocchino, Ferrara (IT); Claudio Cavalieri, Ferrara (IT); Gilberto Moscardi, Ferrara (IT); Sandro Bolognesi, Ferrara (IT)

(73) Assignee: Basell Poliolefine Italia S.r.l., Milano (IT)

(21) Appl. No.: 19/179,531

(22) Filed: Apr. 15, 2025

(30) Foreign Application Priority Data
Apr. 17, 2024 (EP) 24170884.1

(51) Int. Cl. C08L 23/12

(52) U.S. Cl. CPC C08L 23/12; C08L 2203/18; C08L 2205/025

(57) ABSTRACT

A polyolefin composition comprising: A) from 85 wt. % to 99.0 wt. % of a propylene homopolymer; and B) from 1.0 wt. % to 15.0 wt. % of a propylene-ethylene copolymer composition. The propylene-ethylene copolymer composition further comprises: (i) component b1) in an amount ranging from 13 wt. % to 43 wt. %, wherein component b1) is a propylene-ethylene copolymer having a content of ethylene derived units ranging from 0.8 wt. % to 7.1 wt. %; and (ii) component b2) in an amount ranging from 57 wt. % to 87 wt. %, wherein component b2) is a propylene-ethylene copolymer having a content of ethylene derived units ranging from 39.7 wt. % to 76.5 wt. %. A pipe comprising the polyolefin composition.

### PRIOR RELATED APPLICATION

This application claims the benefit of priority to European Patent Application No. 24170884.1, filed on Apr. 17, 2024, which is incorporated here by reference in its entirety.

### FIELD OF THE INVENTION

The present disclosure relates to a composition comprising a propylene homopolymer and an heterophasic propylene ethylene copolymer particularly fit for the production of sewage pipes that have a relatively high impact at low temperatures which allows for the installation of the pipes in low temperature conditions.

### BACKGROUND

Propylene ethylene copolymer are already known in the art for the production of pipes.

For example, according to International Patent Application No. WO 97/33117, one can obtain pipes of the polypropylene plastic material having a high creep resistance, a high long term pressure resistance, improved stiffness and resistance to rapid crack propagation as well. According to the said document, the catastrophic failure of a pipe of polypropylene plastic is prevented when the pipe is made of several layers of different polypropylene plastic material, wherein at least one layer consists of a broad molecular weight distribution (MWD) polypropylene that provides the high creep resistance and at least one layer consists of an elastomer-modified polypropylene that improves the impact strength. The said broad MWD polypropylene is a mixture of a very high molecular weight propylene random copolymer with 1-10 wt. % of ethylene repeating units or a higher-α-olefin repeating units and of a low molecular weight propylene polymer with low (up to 1 wt. %) or zero comonomer content.

It is important to limit the wall thickness of the pipe. By reducing the wall thickness, pipes can be manufactured with less material, resulting in lighter weight. Additionally, these pipes offer improved efficiency in terms of feed rate due to their larger internal diameter compared to smaller diameter pipes typically used in similar applications. However, when the wall thickness becomes too thin, the pipe may become brittle. Therefore, it is essential to use a material with high impact resistance, especially at low temperatures. Furthermore, the material used for the pipe must have a high flexural modulus to ensure rigidity. In polypropylene-based compositions, improving impact performance often leads to a reduction in flexural modulus. The applicant discovered that adding small amounts of heterophasic copolymers with specific characteristics to propylene ethylene copolymer can achieve a good balance between impact resistance and stiffness without significantly compromising stiffness.

### BRIEF SUMMARY

An object of the present disclosure is a polyolefin composition comprising:
A) from 85 wt. % to 99.0 wt. %, based on the total weight of the polyolefin composition, of a propylene homopolymer having the following properties:
   (i) a polydispersity index ranging from 5 to 10,
   (ii) a xylene soluble content at 25° C. ranging from 4.0 wt. % to 1.0 wt. %, based on the total weight of the propylene homopolymer, and
   (iii) a melt flow rate (measured according to ISO 1133 at 230° C./5 kg) ranging from 0.2 g/10 min. to 3.5 g/10 min;
B) from 1.0 wt. % to 15.0 wt. %, based on the total weight of the polyolefin composition, of a propylene-ethylene copolymer composition having the following properties:
   i) a xylene soluble fraction at 25° C. ranging from 44 wt. % to 70 wt. %, based on the total weight of the propylene-ethylene copolymer composition,
   ii) a melt flow rate (measured according to ISO 1133 at 230° C./2.16 kg) ranging from 0.1 g/10 min. to 2.0 g/10 min.,
   iii) an intrinsic viscosity, measured in tetralin, of the fraction soluble in xylene at 25° C. ranging from 2.6 dl/g to 6.1 dl/g, and
   iv) a content of ethylene derived units ranging from 31.5 wt. % to 52.3 wt. %, based on the total weight of the propylene-ethylene copolymer composition;
   wherein the propylene-ethylene copolymer composition, component B, further comprises:
      b1) from 13 wt. % to 43 wt. %, based on the total weight of the propylene-ethylene copolymer composition, of a propylene-ethylene copolymer having a melt flow rate MFR1 (measured according to ISO 1133 at 230° C./2.16 kg) ranging from 22.0 g/10 min. to 50.0 g/10 min., and a content of ethylene derived units ranging from 0.8 wt. % to 7.1 wt. %, based on the total weight of the propylene-ethylene copolymer; and
      b2) from 57 wt. % to 87 wt. %, based on the propylene-ethylene copolymer composition, of a propylene-ethylene copolymer having a content of ethylene derived units ranging from 39.7 wt. % to 76.5 wt. %; and
wherein the polyolefin composition has an melt flow rate (measured according to ISO 1133 at 230° C./5 kg) ranging from 0.4 g/10 min. to 4.0 g/10 min.; and wherein the sum of amounts of component A)+component B) is 100 wt. % and the sum of amounts of component b1)+component b2) is 100 wt. %.

### DETAILED DESCRIPTION

The present disclosure provides a polyolefin composition that has a good balance between impact resistance and stiffness without significantly compromising stiffness. The good balance between impact resistance and stiffness is achieved by adding small amounts of heterophasic copolymers with specific characteristics to propylene ethylene copolymer.

More specifically, the present disclosure provides a polyolefin composition comprising:
A) from 85 wt. % to 99.0 wt. %, based on the total weight of the polyolefin composition, of a propylene homopolymer having the following properties:
   (i) a polydispersity index ranging from 5 to 10,
   (ii) a xylene soluble content at 25° C. ranging from 4.0 wt. % to 1.0 wt. %, based on the total weight of the propylene homopolymer, and
   (iii) a melt flow rate (measured according to ISO 1133 at 230° C./5 kg) ranging from 0.2 g/10 min. to 3.5 g/10 min;
B) from 1.0 wt. % to 15.0 wt. %, based on the total weight of the polyolefin composition, of a propylene-ethylene copolymer composition having the following properties:
   i) a xylene soluble fraction at 25° C. ranging from 44 wt. % to 70 wt. %, based on the total weight of the propylene-ethylene copolymer composition,
   ii) a melt flow rate (measured according to ISO 1133 at 230° C./2.16 kg) ranging from 0.1 g/10 min. to 2.0 g/10 min.,
   iii) an intrinsic viscosity, measured in tetralin, of the fraction soluble in xylene at 25° C. ranging from 2.6 dl/g to 6.1 dl/g, and
   iv) a content of ethylene derived units ranging from 31.5 wt. % to 52.3 wt. %, based on the total weight of the propylene-ethylene copolymer composition;
   wherein the propylene-ethylene copolymer composition, component B, further comprises:
      b1) from 13 wt. % to 43 wt. %, based on the total weight of the propylene-ethylene copolymer composition, of a propylene-ethylene copolymer having a melt flow rate MFR1 (measured according to ISO 1133 at 230° C./2.16 kg) ranging from 22.0 g/10 min. to 50.0 g/10 min., and a content of ethylene derived units ranging from 0.8 wt. % to 7.1 wt. %, based on the total weight of the propylene-ethylene copolymer; and
      b2) from 57 wt. % to 87 wt. %, based on the propylene-ethylene copolymer composition, of a propylene-ethylene copolymer having a content of ethylene derived units ranging from 39.7 wt. % to 76.5 wt. %; and
wherein the polyolefin composition has an melt flow rate (measured according to ISO 1133 at 230° C./5 kg) ranging from 0.4 g/10 min. to 4.0 g/10 min.; and wherein the sum of amounts of component A)+component B) is 100 wt. % and the sum of amounts of component b1)+component b2) is 100 wt. %.

### Component A)—Propylene Homopolymer

In some embodiments, the polyolefin composition may contain from 85.0 wt. % to 99.0 wt. %, of a propylene homopolymer. The polyolefin composition may contain 90 wt. % to 98.5 wt. % or from 93 wt. % to 98 wt. % of the propylene homopolymer. All weights are based on the total weight of the polyolefin composition.

In some embodiments, the propylene homopolymer has a polydispersity ranging from 5 to 10. In some embodiments, the propylene homopolymer has a xylene soluble content at 25° C. ranging from 4.0 wt. % to 1.0 wt. %, based on the total weight of the propylene homopolymer. The propylene homopolymer may have a xylene soluble content at 25° C. ranging from 3.0 wt. % to 2.0 wt. %, based on the total weight of the propylene homopolymer. Additionally, the propylene homopolymer may have a melt flow rate ranging from 0.2 g/10 min. to 3.5 g/10 min. The propylene homopolymer may have a melt flow rate ranging from 0.6 g/10 min. to 2.0 g/10 min.

In some embodiments, the propylene homopolymer is endowed with one or more of features:
i) a flexural modulus, determined according to the method ISO 178:2019, ranging from 1500 MPa to 2300 MPa or ranging from 1800 MPa to 2200 MPa,
ii) an Izod Impact Test at 0° C., measured according to ISO 180/A, with specimen injection moulded according to ISO 1873-2 ranging from 3.0 kJ/m² to 6.0 kJ/m² or ranging from 3.8 kJ/m² to 5.3 kJ/m²,
iii) a melting point, measured by DSC, ranging from 155° C. to 170° C. or ranging from 160° C. to 167° C.

### Component B)—Propylene-Ethylene Copolymer Composition

In some embodiments, the polyolefin composition may contain from 1.0 wt. % to 15.0 wt. %, based on the total weight of the polyolefin composition, of a propylene-ethylene copolymer composition. The polyolefin composition may contain from 1.5 wt. % to 10.0 wt. % or from 2.0 wt. % to 7.0 wt. %, of the propylene-ethylene copolymer composition.

In some embodiments, the propylene-ethylene copolymer composition may contain a fraction that is soluble in xylene at 25° C. ranging from 44 wt. % to 70 wt. %, based on the total weight of the propylene-ethylene copolymer composition. The propylene-ethylene copolymer composition may contain from 47.0 wt. % to 67.0 wt. % or from 52.0 wt. % to 63.0 wt. % of a fraction that is soluble in xylene at 25° C.

In some embodiments, the propylene-ethylene copolymer composition may have a melt flow rate (230° C./2.16 kg., ISO 1133) ranging from 0.1 g/10 min. to 1.0 g/10 min. The propylene-ethylene copolymer composition may have a melt flow rate ranging from 0.2 g/10 min. to 1.6 g/10 min. or from 0.3 g/10 min. to 1.4 g/10 min.

In some embodiments, the propylene-ethylene copolymer composition contains a fraction that is insoluble in xylene at 25° C., and the fraction that is insoluble in xylene at 25° C. has an intrinsic viscosity ranging from 2.6 dl/g to 6.1 dl/g. The fraction that is insoluble in xylene at 25° C. may have an intrinsic viscosity ranging from 2.8 dl/g to 5.6 dl/g or from 3.1 dl/g to 5.2 dl/g.

In some embodiments, the propylene-ethylene copolymer composition has a content of ethylene derived units ranging from 31.5 wt. % to 52.3 wt. %, based on the total weight of the propylene-ethylene copolymer composition. The propylene-ethylene copolymer composition may have a content of ethylene derived units ranging from 33.4 wt. % to 49.9 wt. % or from 36.3 wt. % to 48.2 wt. %, based on the total weight of the propylene-ethylene copolymer composition.

The propylene-ethylene copolymer composition further comprises components b1) and b2). Component b1) is a propylene-ethylene copolymer and component b2) is a propylene-ethylene copolymer.

In some embodiments, the propylene-ethylene copolymer composition comprises component b1) in an amount ranging from 13 wt. % to 43 wt. %, from 18 wt. % to 38 wt. %, or from 21 wt. % to 35 wt. %, based on the total weight of the propylene-ethylene copolymer composition. In some embodiments, component b1) has a melt flow rate MFR1 (230° C./2.16 kg ISO 1133) ranging from 22.0 g/10 min. to 50.0 g/10 min., from 25.0 g/10 min. to 48.0 g/10 min., or from 27.0 g/10 min. to 45.0 g/10 min. Also, component b1) has a content of ethylene derived units ranging from 0.8 wt. % to 7.1 wt. %, 1.4 wt. % to 6.2 wt. %, or from 1.9 wt. % to 5.1 wt. %, based on the total weight of component b1).

In some embodiments, the propylene-ethylene copolymer composition comprises component b2) in an amount ranging from 57 wt. % to 87 wt. %, from 62 wt. % to 82 wt. %, or from 65 wt. % to 79 wt. %, based on the total weight of the propylene-ethylene copolymer composition. In some embodiments, component b2) has a content of ethylene derived units ranging from 39.7 wt. % to 76.5 wt. %, from 45.8 wt. % to 70.3 wt. %, or from 49.8 wt. % to 66.3 wt. %, based on the total weight of component b2).

The term “copolymer” means a polymer containing only two monomeric units, for example, propylene and ethylene.

The term “g/10 min.” means gram per 10 minutes. The term “min.” refers to “minutes.”

### The Polyolefin Composition

The polyolefin composition of the present disclosure preferably shows a Charpy Impact Test measured according to ISO 179-1:2010 at 23° C. ranging from 55.0 KJ/m² to 80.0 kJ/m², from 60.0 kJ/m² to 75.0 kJ/m², or from 63.0 kJ/m² to 72.0 kJ/m². The tensile modulus of the polyolefin composition is measured according to ISO 527-2 and ranges from 1,600 MPa to 2,500 MPa, from 1,700 MPa to 2,300 MPa, or from 1,800 MPa to 2,200 MPa. The flexural modulus of the polyolefin composition of the present disclosure is measured according to ISO 178:2019, and ranges from 1,600 MPa to 2,400 MPa, from 1,700 MPa to 2,200 MPa, or from 1,800 MPa to 2,100 MPa.

In some embodiments, the polyolefin composition has a melt flow rate (measured according to ISO 1133 at 230° C./5 kg) ranging from 0.4 g/10 min. to 4.0 g/10 min., from 0.7 g/10 min. to 3.2 g/10 min., or from 1.0 g/10 min. to 2.7 g/10 min.

With the polyolefin composition of the present disclosure it is possible to obtain pipes, in particular sewage pipes having high modulus and high impact resistance. In particular, it is possible to improve the impact resistance without lowering the modulus.

Thus, a further object of the present disclosure is a pipe comprising the composition of the present disclosure.

The term “pipe” as used herein also includes pipe fittings, valves and all parts which are commonly necessary for e.g., a hot water piping system. Also included within the definition are single and multilayer pipes, where for example one or more of the layers is a metal layer and which may include an adhesive layer.

Such articles can be manufactured through a variety of industrial processes well known in the art, such as for instance moulding, extrusion, and the like.

The composition of the present disclosure may further comprises an inorganic filler agent in an amount ranging from 0.5 to 60 parts by weight with respect to 100 parts by weight of the said composition. Typical examples of such filler agents are calcium carbonate, barium sulphate, titanium dioxide and talc. Talc and calcium carbonate are preferred. A number of filler agents can also have a nucleating effect, such as talc that is also a nucleating agent. The amount of a nucleating agent is typically from 0.2 to 5 wt. % with respect to the polymer amount.

The composition of the disclosure is also suitable for providing pipes with walls of any configuration other than those with smooth inner and outer surface. Examples are pipes with a sandwich-like pipe wall, pipes with a hollow wall construction with longitudinally extending cavities, pipes with a hollow wall construction with spiral cavities, pipes with a smooth inner surface and a compact or hollow, spirally shaped, or an annularly ribbed outer surface, independently of the configuration of the respective pipe ends.

Articles, pressure pipes and related fittings according to the present disclosure are produced in a manner known per se, e.g. by (co-)extrusion or moulding, for instance.

Extrusion of articles can be made with different type of extruders for polyolefin, e.g. single or twin screw extruders.

A further embodiment of the present disclosure is a process wherein the said composition is moulded into said articles.

When the pipes are multi-layer, at least one layer is made of the polyolefin composition described above. The further layer(s) is/are made of an amorphous or crystalline polymer (such as homopolymer and co- or terpolymer) of R—CH═CH₂ olefins, where R is a hydrogen atom or a C₁-C₆ alkyl radical. Particularly preferred are the following polymers:

isotactic or mainly isotactic propylene homopolymers;

random co- and terpolymers of propylene with ethylene and/or C4-C8 α-olefin, such as 1-butene, 1-hexene, 1-octene, 4-methyl-1-pentene, wherein the total comonomer content ranges from 0.05% to 20% by weight, or mixture of said polymers with isotactic or mainly isotactic propylene homopolymers;

heterophasic polymer blends comprising (a) a propylene homopolymer and/or one of the co- and terpolymers of item (2), and an elastomeric moiety (b) comprising co- and terpolymers of ethylene with propylene and/or a C4-C8 α-olefin, optionally containing minor amounts of a diene, the same disclosed for polymer (2)(a); and

amorphous polymers such as fluorinated polymers, polyvinyl difluoride (PVDF) for example.

In multi-layer pipes the layers of the pipe can have the same or different thickness.

The composition of the present disclosure can be prepared by blending the various components A), b1), and b2) or by preparing component A) and blend this component with component B) prepared in a single polymerization process by sequential polymerization steps.

The polymerization of A) and B) can be carried out in the presence of Ziegler-Natta catalysts. An essential component of said catalysts is a solid catalyst component comprising a titanium compound having at least one titanium-halogen bond, and an electron-donor compound, both supported on a magnesium halide in active form. Another essential component (co-catalyst) is an organoaluminium compound, such as an aluminium alkyl compound.

An external donor is optionally added.

The catalysts generally used in the process of the disclosure are capable of producing polypropylene with a value of xylene insolubility at ambient temperature greater than 90%, preferably greater than 95%.

Catalysts having the above mentioned characteristics are well known in the patent literature; particularly advantageous are the catalysts described in U.S. Pat. No. 4,399,054 and European patent 45977. Other examples can be found in U.S. Pat. No. 4,472,524.

The solid catalyst components used in said catalysts comprise, as electron-donors (internal donors), compounds selected from the group consisting of ethers, ketones, lactones, compounds containing N, P and/or S atoms, and esters of mono- and dicarboxylic acids.

Particularly suitable electron-donor compounds are esters of phtalic acid and 1,3-diethers of formula:

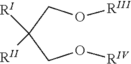

wherein RI and RII are the same or different and are C1-C18 alkyl, C3-C18 cycloalkyl or C7-C18 aryl radicals; RIII and RIV are the same or different and are C₁-C₄ alkyl radicals; or are the 1,3-diethers in which the carbon atom in position 2 belongs to a cyclic or polycyclic structure made up of 5, 6, or 7 carbon atoms, or of 5-n or 6-n′ carbon atoms, and respectively n nitrogen atoms and n′ heteroatoms selected from the group consisting of N, O, S and Si, where n is 1 or 2 and n′ is 1, 2, or 3, said structure containing two or three unsaturations (cyclopolyenic structure), and optionally being condensed with other cyclic structures, or substituted with one or more substituents selected from the group consisting of linear or branched alkyl radicals; cycloalkyl, aryl, aralkyl, alkaryl radicals and halogens, or being condensed with other cyclic structures and substituted with one or more of the above mentioned substituents that can also be bonded to the condensed cyclic structures; one or more of the above mentioned alkyl, cycloalkyl, aryl, aralkyl, or alkaryl radicals and the condensed cyclic structures optionally containing one or more heteroatom(s) as substitutes for carbon or hydrogen atoms, or both.

Ethers of this type are described in published European patent applications 361493 and 728769.

Representative examples of said diethers are 2-methyl-2-isopropyl-1,3-dimethoxypropane, 2,2-diisobutyl-1,3-dimethoxypropane, 2-isopropyl-2-cyclopentyl-1,3-dimethoxypropane, 2-isopropyl-2-isoamyl-1,3-dimethoxypropane, 9,9-bis(methoxymethyl) fluorene.

Other suitable electron-donor compounds are phthalic acid esters, such as diisobutyl, dioctyl, diphenyl and benzylbutyl phthalate.

The preparation of the above mentioned catalyst component is carried out according to various methods.

For example, a MgCl₂·nROH adduct (in particular in the form of spheroidal particles) wherein n is generally from 1 to 3 and ROH is ethanol, butanol or isobutanol, is reacted with an excess of TiCl₄ containing the electron-donor compound. The reaction temperature is generally from 80 to 120° C. The solid is then isolated and reacted once more with TiCl₄, in the presence or absence of the electron-donor compound, after which it is separated and washed with aliquots of a hydrocarbon until all chlorine ions have disappeared.

In the solid catalyst component the titanium compound, expressed as Ti, is generally present in an amount from 0.5 to 10% by weight. The quantity of electron-donor compound which remains fixed on the solid catalyst component generally is 5 to 20% by moles with respect to the magnesium dihalide.

The titanium compounds, which can be used for the preparation of the solid catalyst component, are the halides and the halogen alcoholates of titanium. Titanium tetrachloride is the preferred compound.

The reactions described above result in the formation of a magnesium halide in active form. Other reactions are known in the literature, which cause the formation of magnesium halide in active form starting from magnesium compounds other than halides, such as magnesium carboxylates.

The Al-alkyl compounds used as co-catalysts comprise the Al-trialkyls, such as Al-triethyl, Al-triisobutyl, Al-tri-n-butyl, and linear or cyclic Al-alkyl compounds containing two or more Al atoms bonded to each other by way of O or N atoms, or SO₄ or SO₃ groups.

The Al-alkyl compound is generally used in such a quantity that the Al/Ti ratio be from 1 to 1000.

The electron-donor compounds that can be used as external donors include aromatic acid esters such as alkyl benzoates, and in particular silicon compounds containing at least one Si—OR bond, where R is a hydrocarbon radical.

Examples of silicon compounds are (tert-butyl)₂Si(OCH₃)₂, (cyclohexyl)(methyl)Si (OCH₃)₂, (cyclopentyl)₂Si(OCH₃)₂ and (phenyl)₂Si(OCH₃)₂ and (1,1,2-trimethylpropyl)Si(OCH₃)₃.

1,3-diethers having the formulae described above can also be used advantageously. If the internal donor is one of these diethers, the external donors can be omitted.

In particular, even if many other combinations of the previously said catalyst components may allow to obtain compositions according to the present disclosure, the components A) and B) are preferably prepared by using catalysts containing a phthalate as internal donor and (cyclopentyl)₂Si(OCH₃)₂ as external donor, or the said 1,3-diethers as internal donors.

A further The Ziegler-Natta catalysts that can be used to produce a propylene polymer of the present disclosure is a solid catalyst component comprising a magnesium halide, a titanium compound having at least a Ti-halogen bond as above described and at least two electron donor compounds selected from succinates and the other being selected from 1,3 diethers.

Component A) is preferably produced with a polymerization process illustrated in EP application 1 012 195.

In detail, the said process comprises feeding the monomers to said polymerisation zones in the presence of catalyst under reaction conditions and collecting the polymer product from the said polymerisation zones. In the said process the growing polymer particles flow upward through one (first) of the said polymerisation zones (riser) under fast fluidisation conditions, leave the said riser and enter another (second) polymerisation zone (downcomer) through which they flow downward in a densified form under the action of gravity, leave the said downcomer and are reintroduced into the riser, thus establishing a circulation of polymer between the riser and the downcomer.

In the downcomer high values of density of the solid are reached, which approach the bulk density of the polymer. A positive gain in pressure can thus be obtained along the direction of flow, so that it become to possible to reintroduce the polymer into the riser without the help of special mechanical means. In this way, a “loop” circulation is set up, which is defined by the balance of pressures between the two polymerisation zones and by the head loss introduced into the system.

Generally, the condition of fast fluidization in the riser is established by feeding a gas mixture comprising the relevant monomers to the said riser. It is preferable that the feeding of the gas mixture is effected below the point of reintroduction of the polymer into the said riser by the use, where appropriate, of gas distributor means. The velocity of transport gas into the riser is higher than the transport velocity under the operating conditions, preferably from 2 to 15 m/s.

Generally, the polymer and the gaseous mixture leaving the riser are conveyed to a solid/gas separation zone. The solid/gas separation can be effected by using conventional separation means. From the separation zone, the polymer enters the downcomer. The gaseous mixture leaving the separation zone is compressed, cooled and transferred, if appropriate with the addition of make-up monomers and/or molecular weight regulators, to the riser. The transfer can be effected by means of a recycle line for the gaseous mixture.

The control of the polymer circulating between the two polymerisation zones can be effected by metering the amount of polymer leaving the downcomer using means suitable for controlling the flow of solids, such as mechanical valves.

The operating parameters, such as the temperature, are those that are usual in olefin polymerisation process, for example between 50 to 120° C.

This first stage process can be carried out under operating pressures of between 0.5 and 10 MPa, preferably between 1.5 to 6 MPa.

Advantageously, one or more inert gases are maintained in the polymerisation zones, in such quantities that the sum of the partial pressure of the inert gases is preferably between 5 and 80% of the total pressure of the gases. The inert gas can be nitrogen or propane, for example.

The various catalysts are fed up to the riser at any point of the said riser. However, they can also be fed at any point of the downcomer. The catalyst can be in any physical state, therefore catalysts in either solid or liquid state can be used.

The following examples are given to illustrate the present disclosure without limiting purpose.

### EXAMPLES

### Characterization Methods

### Xylene-Soluble (XS) Fraction at 25° C.

Xylene Solubles at 25° C. have been determined according to ISO 16 152.

### DSC Method for Melting Point

Melting point has been measured according to ISO 11357-3, at scanning rate of 20 C/min both in cooling and heating, on a sample of weight between 5 and 7 mg., under inert N2 flow. Instrument calibration made with indium

Melt Flow Rate: Determined according to the method ISO 1133 (230° C., 5 kg or 2.16 kg).

### Ethylene Content in the Copolymers

¹³C NMR spectra were acquired on a Bruker AV-600 spectrometer equipped with cryoprobe, operating at 160.91 MHz in the Fourier transform mode at 120° C.

The peak of the Sββ carbon (nomenclature according to “Monomer Sequence Distribution in Ethylene-Propylene Rubber Measured by ¹³C NMR. 3. Use of Reaction Probability Mode” C. J. Carman, R. A. Harrington and C. E. Wilkes, Macromolecules, 1977, 10, 536) was used as an internal reference at 29.9 ppm. The samples were dissolved in 1,1,2,2-tetrachloroethane-d2 at 120° C. with a 8% wt/v concentration. Each spectrum was acquired with a 900 pulse, and 15 seconds of delay between pulses and CPD to remove ¹H-¹³C coupling. 512 transients were stored in 32K data points using a spectral window of 9000 Hz.

The assignments of the spectra, the evaluation of triad distribution and the composition were made according to Kakugo (“Carbon-13 NMR determination of monomer sequence distribution in ethylene-propylene copolymers prepared with 6-titanium trichloride-diethyl-aluminum chloride” M. Kakugo, Y. Naito, K. Mizunuma and T. Miyatake, Macromolecules, 1982, 15, 1150) using the following equations:

$$PPP = 100 T ββ / S \\ PEP = 100 S ββ / S \\ PPE = 100 T βδ / S \\ PEE = 100 S βδ / S \\ EPE = 100 T δδ / S \\ EEE = 100 ( 0.25 S γδ + 0.5 S δδ ) / S \\ S = T ββ + T β δ + T δ δ + S β β + S β δ + 0.25 S γδ + 0.5 S δδ$$

The molar percentage of ethylene content was evaluated using the following equation:

$$E \% mol = 100 * [ PEP + PEE + EEE ]$$

The weight percentage of ethylene content was evaluated using the following equation:

$$100 * E \% mol * MWE \\ E \% wt . = E \% mol * MWE + P \% mol * MWP$$

where P % mol is the molar percentage of propylene content, while MWE and MWP are the molecular weights of ethylene and propylene, respectively.

Preparation of injection molded specimens: test specimens 80×10×4 mm were obtained according to the method ISO 1873-2:2007.

Flexural modulus: Determined according to the method ISO 178:2019 on injection molded test specimens.

Tensile Modulus: Determined according to ISO 527-2, on injection molded test specimens.

Charpy Impact test: measured according to ISO 179-1:2010 on injection molded specimens.

Izod impact test, measured according to ISO 180/A, with specimen injection moulded according to ISO 1873-2.

Polydispersity Index (PI): Determined at a temperature of 200° C. by using a parallel plates rheometer model RMS-800 marketed by RHEOMETRICS (USA), operating at an oscillation frequency which increases from 0.1 rad/sec to 100 rad/sec. From the crossover modulus one can derive the P.I. by way of the equation:

$$P . I . = 105 / Gc$$

in which Gc is the crossover modulus which is defined as the value (expressed in Pa) at which G′=G″ wherein G′ is the storage modulus and G″ is the loss modulus. Component A)

### Preparation of the Solid Catalyst Component for Component A)

Into a 2000 mL five-necked glass reactor, equipped with mechanical stirrer, jacket and a thermocouple, purged with nitrogen, 1000 mL of TiCl₄ were introduced and the reactor cooled at −5° C. While stirring, 60.0 g of microspheroidal MgCl₂·1.7C₂H₅OH having average particle size of 58 μm (prepared in accordance with the method described in example 1 of EP728769) was added at −5° C. The temperature was raised at 40° C. and an amount of diethyl 2,3-diisopropylsuccinate such as to have a Mg/succinate molar ratio of 13 was added. The temperature was raised to 100° C. and kept at this value for 60 min. After that the stirring was stopped for 15 min and the solid settled down. The liquid was siphoned off. After siphoning, fresh TiCl₄ and an amount of 9,9-bis(methoxymethyl)fluorene such to have a Mg/diether molar ratio of 26 was added. Then the temperature was raised to 110° C. and kept for 30 minutes under stirring. The reactor was then cooled at 75° C. and the stirrer was stopped for 15 min. After sedimentation and siphoning, fresh TiCl₄ was added. Then the temperature was raised to 90° C. and the suspension was stirred for 15 min. The temperature was then decreased to 75° C. and the stirrer was stopped, for 15 min. After sedimentation and siphoning at the solid was washed six times with anhydrous hexane (6×1000 ml) at 60° C. and one time with hexane at 25° C. The solid was dried in a rotavapor.

### Preparation of the Catalyst System

Before introducing it into the polymerization reactors, the solid catalyst component described above was contacted with aluminum-triethyl (TEAL) and dicyclopentyl-dimethoxysilane (DCPMS) at a temperature of 15° C.

### Prepolymerization

The catalyst system was then subject to prepolymerization treatment at 20° C. by maintaining it in suspension in liquid propylene for a residence time of 9 minutes before introducing it into the polymerization reactor.

The polymerization runs were conducted in continuous in a polymerisation apparatus as described in EP 1 012 195.

The catalyst is sent to the polymerisation apparatus that comprises two interconnected cylindrical reactors, riser and downcomer. Fast fluidisation conditions are established in the riser by recycling gas from the gas-solid separator. Hydrogen was used as molecular weight regulator. The polymerization conditions are reported on Table 1. Component A is the component A used in example 1 of WO2016/050461.

TABLE 1

Component A)

| TEAL/external donor | | wt/wt | 6 |
|---|---|---|---|
| TEAL/catalyst | | wt/wt | 6 |
| Temperature | | ° C. | 73 |
| Pressure | | bar-g | 27 |
| Split holdup | riser | wt. % | 40 |
| | downcomer | wt. % | 60 |

| C₃⁻ riser | mole % | 80 |
|---|---|---|
| | mole % | 1.3 |
| H₂/C₃⁻ riser | mol/mol | 0.028 |
| H₂/C₃⁻ downcomer | mol/mol | 0.016 |

C₃⁻ = propylene

The properties of component A has been reported on Table 2.

TABLE 2

| Component A | | |
|---|---|---|
| MFR 5 Kg/230° C. | g/10 min | 1.3 |
| Polydispersity (PI) | | 6.0 |
| Xylene solubles at 25° C. | % | <2 |
| Flexural modulus | MPa | 2050 |
| Tensile modulus | MPa | 1960 |
| IZOD 0° C. | kJ/m² | 4.3 |
| Stress at yield | % | 36 |
| Elongation at break | kJ/m² | 28 |
| Tm | ° C. | 164 |

### Components B)

Component B1) is a commercial heterophasic polymer obtained by sequential gas phase polymerization used in example 1 of WO2016/050461 as component B).

Component B2) is a commercial heterophasic polymer obtained by sequential gas phase polymerization. Sold by LyondellBasell under the tradenameCA7469A the features of the polymer are reported on Table 3

TABLE 3

| Component | | B1 | B2 |
|---|---|---|---|
| Component b1 | | | |
| Split | % wt | 30 | 29 |
| MFR 2.16 Kg/230° C. | g/10 min | 85 | 34.5 |
| Xylene solubles at 25° C. | wt. % | 2.0 | 5.0 |
| C2 | wt. % | — | 2.5 |
| Component b2 | | | |
| Split | wt. % | 70 | 71 |
| C2 | wt. % | 38.5 | 58 |
| Total polymer | | | |
| MFR 2.16 kg/230° C. | g/10 min. | — | 0.5 |
| intrinsic viscosity of the | dl/g | 2.7 | 4.3 |
| xylene soluble fraction at | | | |
| 25° C. of the whole polymer | | | |
| Xylene solubles at 25° C. | wt. % | — | 58 |

*C2 = ethylene derived units

Components A and B have been blended. The properties of the resulting blends are reported on Table 4 to be compared with the properties of comparative examples 2.

TABLE 4

| | | | Comp | Comp |
|---|---|---|---|---|
| Blend | | 1 | 2 | 3 |
| Component | | B2 | B1 | — |
| Split* | wt. % | 5.2 | 5.2 | 0 |
| MFR 5 kg | g/10 min | 1.7 | 1.8 | 1.3 |
| 230° C. | | | | |
| Charpy at 23° C. | kJ/m² | 68.2 | 54 | 4.3 |
| Charpy at 0° C. | kJ/m² | 6.0 | 3.6 | 3.1 |
| Flexural | MPa | 1910 | 1930 | 2050 |
| modulus | | | | |
| Tensile | % | 2050 | 2120 | — |
| modulus | | | | |

*The remaining amount being component A. Comparative example 3 is component A alone.

From Table 4 clearly result that the impact properties of the blend 1 is higher with respect to comparative blend 2 and component A alone, while flexural modulus and tensile modulus are substantially unchanged.

What is claimed is:

1. A polyolefin composition comprising:
A) from 85 wt. % to 99.0 wt. %, based on the total weight of the polyolefin composition, of a propylene homopolymer having the following properties:
(i) a polydispersity index ranging from 5 to 10,
(ii) a xylene soluble content at 25° C. ranging from 4.0 wt. % to 1.0 wt. %, based on the total weight of the propylene homopolymer, and
(iii) a melt flow rate (measured according to ISO 1133 at 230° C./5 kg) ranging from 0.2 g/10 min. to 3.5 g/10 min.;
B) from 1.0 wt. % to 15.0 wt. %, based on the total weight of the polyolefin composition, of a propylene-ethylene copolymer composition having the following properties:
i) a xylene soluble fraction at 25° C. ranging from 44 wt. % to 70 wt. %, based on the total weight of the propylene-ethylene copolymer composition,
ii) a melt flow rate (measured according to ISO 1133 at 230° C./2.16 kg) ranging from 0.1 g/10 min. to 2.0 g/10 min.,
iii) an intrinsic viscosity, measured in tetralin, of the fraction soluble in xylene at 25° C. ranging from 2.6 dl/g to 6.1 dl/g, and
iv) a content of ethylene derived units ranging from 31.5 wt. % to 52.3 wt. %, based on the total weight of the propylene-ethylene copolymer composition;
wherein the propylene-ethylene copolymer composition, component B, further comprises:
b1) from 13 wt. % to 43 wt. %, based on the total weight of the propylene-ethylene copolymer composition, of a propylene-ethylene copolymer having a melt flow rate MFR1 (measured according to ISO 1133 at 230° C./2.16 kg) ranging from 22.0 g/10 min. to 50.0 g/10 min., and a content of ethylene derived units ranging from 0.8 wt. % to 7.1 wt. %, based on the total weight of the propylene-ethylene copolymer; and
b2) from 57 wt. % to 87 wt. %, based on the propylene-ethylene copolymer composition, of a propylene-ethylene copolymer having a content of ethylene derived units ranging from 39.7 wt. % to 76.5 wt. %; and
wherein the polyolefin composition has a melt flow rate (measured according to ISO 1133 at 230° C./5 kg) ranging from 0.4 g/10 min. to 4.0 g/10 min.; and
wherein the sum of amounts of component A)+component B) is 100 wt. % and the sum of amounts of component b1)+component b2) is 100 wt. %.

2. The polyolefin composition according to claim 1, wherein component A) ranges from 90 wt. % to 98.5 wt. %, and component B) ranges from 1.5 wt. % to 10.0 wt. %.

3. The polyolefin composition according to claim 1, wherein b1) ranges from 18 wt. % to 38 wt. %, and b2) ranges from 62 wt. % to 82 wt. %.

4. The polyolefin composition according to claim 1, wherein the polyolefin composition has a melt flow rate ranging from 0.7 g/10 min. to 3.2 g/10 min.

5. The polyolefin composition according to claim 1, wherein in component b1) has a content of ethylene derived units ranging from 1.4 wt. % to 6.2 wt. %.

6. The polyolefin composition according to claim 1, wherein in component B) fraction soluble in xylene at 25° C. has an intrinsic viscosity, measured in tetralin, ranging from 2.8 dl/g to 5.6 dl/g.

7. The polyolefin composition according to claim 1, wherein in the component B) contains a fraction soluble in xylene at 25° C. ranging from 47 wt. % to 67 wt. %.

8. The polyolefin composition according to claim 1, wherein component b1) has a melt flow rate MFR1 (230° C./2.16 kg ISO 1133) ranging from 25.0 g/10 min to 48.0 g/10 min.

9. The polyolefin composition according to claim 1, wherein component b2) has a content of ethylene derived units ranging from 45.8 wt. % to 70.3 wt. %.

10. The polyolefin composition according to claim 1, wherein component B) has a content of ethylene derived units ranging from 33.4 wt. % to 49.9 wt. %.

11. The polyolefin composition according to claim 1, wherein component A) has a xylene soluble content at 25° C. ranging from 3.0 wt. % to 2.0 wt. %.

12. The polyolefin composition according to claim 1, wherein component A) is present in an amount ranging from 93 wt. % to 98 wt. %, and component B) is present in an amount ranging from 2.0 wt. % to 7.0. wt. %.

13. The polyolefin composition according to claim 1, wherein component B) contains a fraction soluble in xylene at 25° C. in an amount ranging from 52.0 wt. % to 63.0 wt. %.

14. The polyolefin composition according to claim 1, wherein component B) contains a fraction soluble in xylene at 25° C. and wherein the fraction soluble in xylene at 25° C. has an intrinsic viscosity, measured in tetralin, ranging from 3.1 dl/g to 5.2 dl/g.

15. A pipe comprising the polyolefin composition of claim 1.
